(19) United States
(12) Patent Application Publication
(10) Pub. No.: US 2010/0186186 A1
(43) Pub. Date: Jul. 29, 2010

(54) WINDSCREEN WIPER DEVICE

(76) Inventor: Xavier Boland, Arlon (BE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/528,872

(22) PCT Filed: Feb. 1, 2008
(86) PCT No.: PCT/EP08/51297

§ 371 Date: Mar. 18, 2010

(30) Foreign Application Priority Data
Feb. 27, 2007 (EP) 07103117.3

(51) Int. Cl. B60S 1/04

(52) U.S. Cl. 15/250.48

(57) ABSTRACT

A windscreen wiper device comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, wherein ends of the longitudinal strip are connected to a respective connecting piece, which windscreen wiper device comprises a connecting device for an oscillating arm, with the special feature that the wiper blade comprises an elongated upper holding part and an elongated lower wiping part of a flexible material, wherein the holding part holds the wiping part, wherein the holding part comprises downwardly extending side arms, seen in cross-section, for pivotally engaging the wiping part from the outside in a lateral region thereof, and wherein additional engaging means are provided for allowing pivotal engagement between the holding part and the wiping part in an upper region thereof.

### BACKGROUND OF THE INVENTION

1. Technical Field

The present invention relates to a windscreen wiper device comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, wherein ends of the longitudinal strip are connected to a respective connecting piece, which windscreen wiper device comprises a connecting device for an oscillating arm.

2. Related Art

Such a windscreen wiper device is known from international (PCT-) patent publication no. WO 02/1090155 in the name of the same Applicant. The prior art windscreen wiper device is in particular designed as a “yokeless” wiper device, wherein use is no longer made of several yokes pivotally connected to each other, but wherein the wiper blade is biassed by the carrier element, as a result of which it exhibits a specific curvature. In this known windscreen wiper device the wiper blade includes two opposing longitudinal grooves on its longitudinal sides, in which grooves spaced-apart longitudinal strips of the carrier clement arc disposed. Neighbouring ends of the longitudinal strips are interconnected by the respective connecting piece.

A sometimes felt disadvantage of the windscreen wiper device as described in the above international (PCT-) patent publication is that a rubber wiping lip of the wiper blade might show a permanent deformation after several months of use, as the wiping lip has to make many oscillating movements during use, wherein the wiping lip has to bend severely. Bending the rubber of the wiping lip many times back and forth might lead to a permanent deformation of the rubber and thus to deteriorated wiping properties, with all negative consequences involved.

### SUMMARY OF THE INVENTION

It is an object of the invention to improve the prior art, that is to improve a windscreen wiper device known from the above international (PCT-) patent publication, wherein a permanent deformation of the wiping lip is avoided at all times.

In order to accomplish that objective, a windscreen wiper device of the kind referred to in the introduction according to the invention is characterized in that the wiper blade comprises an elongated upper holding part and an elongated lower wiping part of a flexible material, wherein the holding part holds the wiping part, wherein the holding part comprises downwardly extending side arms, seen in cross- section, for pivotally engaging the wiping part, from the outside in a lateral region thereof, and wherein additional engaging means are provided for allowing pivotal engagement between the holding part and the wiping part in an upper region thereof. In other words, a mechanical articulation is realized between the holding part and the wiping part, wherein the holding part holds the wiping part allowing the wiping part to make pivotal or hingeable movements relative to the holding part during use. In use the pivotal movements of the wiping part correspond to oscillatory movements of the oscillating arm. Due to the mechanical articulation the wiping part will not have to bend to follow the oscillatory movements of the oscillating arm, so that a permanent deformation of the wiping part as a result of stress in the rubber thereof is avoided. the additional engaging means ensure that a wiping lip of the wiping part is tumbled over at each turning point of its oscillary movement with the biggest reversal torque. Preferably, the holding part comprises the additional engaging means which extend in downward direction therefrom for pivotally engaging the wiping part in an upper region of the wiping part. In the alternative, the wiping part comprises the additional engaging means which extend in upward direction therefrom for pivotally engaging the holding part.

It is noted that the invention is not restricted to use with passenger cars, but it can also be used with trains and other fast vehicles.

In one preferred embodiment of a windscreen wiper device in accordance with the invention the wiping part comprises a wiping lip, a neck extending from the wiping lip, as well as an enlarged head extending from the neck, wherein the enlarged head is mounted into a hollow chamber defined by the arms of the holding part. Preferably, the enlarged head has a circular, elliptical, square, rectangular, rhomboid or heart-shaped cross-section. the wiping lip is placed in abutment with a windscreen to be wiped. the wiping lip, the neck and the enlarged head particularly are in one piece and extend in longitudinal direction along the entire length of the wiper blade.

Particularly, the additional engaging means pivotally engage the enlarged head at the location of its upper surface. More in particular, the engaging means of the holding part comprise a downwardly extending (elongated) protrusion engaging the enlarged head in a correspondingly shaped slit thereof. the slit is then provided in the upper surface of the enlarged head and preferably extends in longitudinal direction along the entire length of the enlarged head. Preferably, the protrusion extends along the entire length of the wiper blade and is made in one piece with the holding part. In the alternative, the additional engaging means of the wiping part extend upwardly from the enlarged head in a slit of the holding part.

In another preferred embodiment of a windscreen wiper device according to the invention the arms of the holding part comprise inwardly extending end parts, wherein the neck is located at least partly between the end parts, and wherein the enlarged head is located above the end parts. In other words, the enlarged head is confined in the hollow chamber, wherein the hook-shaped end parts further retain the wiping part onto the holding part. Particularly, the hollow chamber comprises a lubricant in order to allow smooth pivotal movements of the wiping part without wear.

In another preferred embodiment of a windscreen wiper device in accordance with the invention the wiping part includes opposing longitudinal grooves on its longitudinal sides, in which grooves spaced-apart longitudinal strips of the carrier element are disposed. In that case the respective connecting piece interconnects neighbouring ends of the longitudinal strips. In the alternative the at least one longitudinal groove is provided in the holding part. In the latter case the groove particularly forms a central groove having a closed circumference.

In another preferred embodiment of a windscreen wiper device according to the invention the holding part is provided with a spoiler at a side thereof facing away from the wiping part the spoiler is preferably in one piece with the holding part. In another preferred embodiment the spoiler is entirely detachably connected to the holding part.

In another preferred embodiment of a windscreen wiper device in accordance with the invention the holding part and the wiping part extend in longitudinal direction along the entire length of the wiper blade. In other words, the wiper blade consists of two mutually cooperating constructional elements, namely the holding part and the wiping part. the parts are preferably slidably connected to each other, wherein the enlarged head of the wiping part is slidably mounted into the hollow chamber of the holding part. the hollow chamber extends along the entire length of the wiper blade so as to form a channel with two open ends. One of the open ends of the channel forms an entrance through which the wiping part as a separate construction element can be slid by hand into the channel until the wiping part is finally retained onto the holding part (the first position). the open end also acts as an exit through which the wiping part can be slid by hand from the first position until the wiping part as a separate “loose” construction element can be replaced or repaired (the second position).

In another preferred embodiment of a windscreen wiper device according to the invention the wiping part is at least substantially made of an elastomeric material, such as rubber, wherein the holding part is at least substantially made of a plastic material.

### THE DRAWINGS

The invention will now be explained in more detail with reference to figures illustrated in a drawing, wherein:

FIG. 1 shows a perspective view of a windscreen wiper device according to a preferred embodiment of the invention; and

FIGS. 2 and 3 are a cross-section of the windscreen wiper device of FIG. 1 at the location of a connecting device for an oscillating arm.

### DETAILED DESCRIPTION

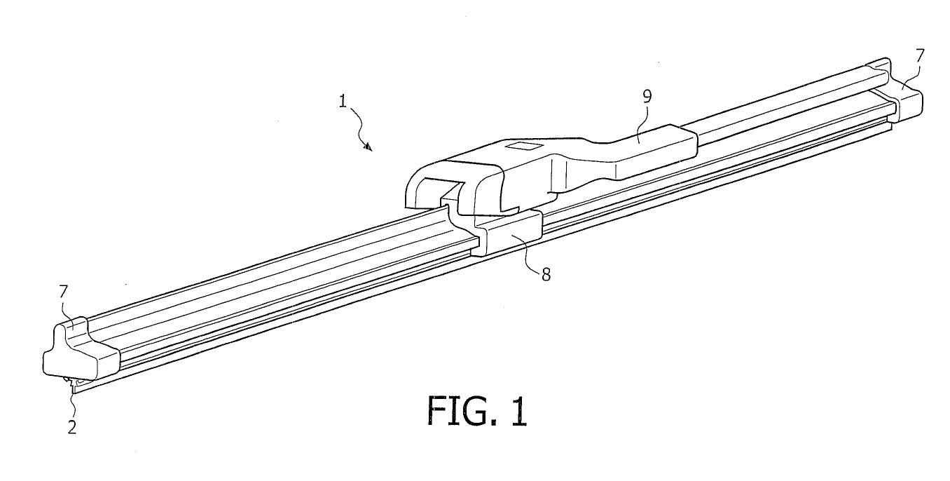

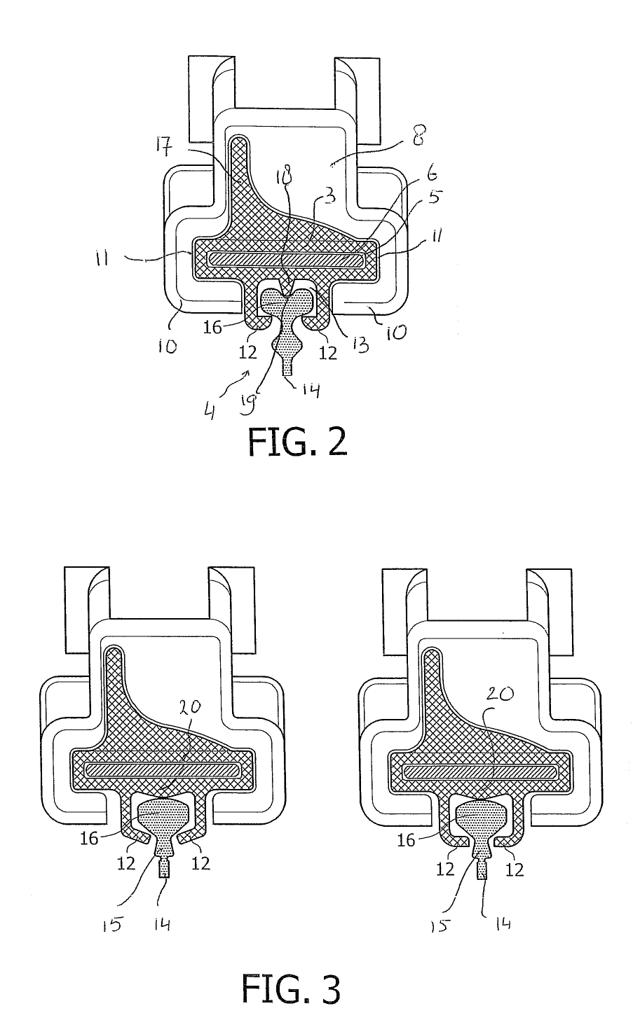

FIG. 1 shows a preferred variant of a windscreen wiper device 1 according to the invention. the windscreen wiper device 1 is built up of a wiper blade 2 consisting of a plastic elongated upper holding part 3 and an elastomeric elongated lower wiping part 4, both extending in longitudinal direction along the entire length of the wiper blade 2. In the holding part 3 a central longitudinal groove 5 is formed, in which a longitudinal strip 6 made of spring band steel is fitted (FIGS. 2 and 3). the strip 6 forms a flexible carrier element for the rubber wiper blade 2, as it were, which is thus biased in a curved position (the curvature in operative position being that of a windscreen to be wiped). Outer ends of the strip 6 are connected on either side of the windscreen wiper device 1 to connecting pieces 7 functioning as clamping members. In this embodiment, the connecting pieces 7 are separate constructional elements, which may be form-locked as well as force-locked to the outer ends of the strip 6. In another preferred variant, the connecting pieces 7 are in one piece with the strip 6 made of spring band steel.

The windscreen wiper device 1 is furthermore built up of a connecting device 8 of plastic material for an oscillating wiper arm 9. the connecting device 8 comprises clamping members 10 that are integral therewith, which engage round longitudinal sides 11 of the holding part 3 that face away from each other, as a result of which the connecting device 8 is firmly attached to the unit consisting of the holding part 3 and the strip 6. Likewise, the connecting pieces 7 comprise similar clamping members. The oscillating wiper arm 9 is pivotally connected to the connecting device 8 about a pivot axis near one end thereof.

As can be seen from FIGS. 2 and 3, the holding part 3 is provided with downwardly extending side arms 12 in one piece therewith, seen in cross-section, thus defining a hollow chamber or space 13, again seen in cross-section. the hollow chamber 13 extends in longitudinal direction along the entire length of the wiper blade 2, so as to form a channel with two open outer ends. Again referring to FIGS. 2 and 3, the wiping part 4 consists of a wiping lip 14, a neck 15 extending from the wiping lip 14, as well as an enlarged head 16 extending from the neck 15 and having a heart-shaped (FIG. 2) or elliptical (FIG. 3) cross-section. the parts 3, 4 are slidably connected to each other, wherein the enlarged head 16 of the wiping part 4 is slidably mounted into the hollow channel of the holding part 3. One of the open ends of the channel forms an entrance through which the wiping part 4 as a separate construction element can be slid by hand into the channel until the wiping part 4 is finally retained onto the holding part 3 (the first or holding position). the open end also acts as an exit through which the wiping part 4 can be slid by hand from the first position until the wiping part 4 as a separate “loose” construction element can be replaced or repaired (the second position). The side arms 12 of the holding part 3 pivotally engage the enlarged head 16 of the wiping part 4, so as to allow a pivotal or hingeable movement of the wiping part 4 when the oscillating wiper arm 9 attached to the holding part 3 makes a corresponding oscillatory movement.

As shown, the holding part 3 is connected to a spoiler 17 at a side thereof facing away from the wiping part 4. the spoiler 17 is made in one piece therewith. If designed as a detachable piece, the spoiler 17 may be equipped with engaging members engaging around longitudinal sides of the holding part 3.

With reference to FIG. 2, a bottom of the holding part 3 is provided with additional engaging means in the form of a downwardly extending protrusion 18 which extends in longitudinal direction along a part of the length of the wiper blade 2 or along the entire length thereof. the protrusion 18 engages into a correspondingly shaped slit 19 provided on an upper surface of the enlarged head 16. As shown in FIG. 2, the wiping part 4 is suspended inside the hollow chamber 13 by means of free ends of the side arms 12 and the protrusion 18. Hence, an unstable design is obtained, wherein the torque is maximal when the wiping lip 14 tumbles over at each turning point of its oscillatory movement.

Referring to FIG. 3, the additional engaging means are now formed by a downwardly extending thickening 20 which again extends in longitudinal direction along a part of the length of the wiper blade 2 or along the entire length thereof the thickening 20 abuts an upper surface of the enlarged head 16. the wiping part 4 is now suspended inside the hollow chamber 13 by means of free ends of the side arms 12 and the thickening 20. Again, an unstable design is obtained, wherein the torque is maximal when the wiping lip 14 tumbles over at each turning point of its oscillatory movement.

Although not depicted in the figures, it will be clear for a person skilled in the art that the oscillating wiper arm 9 is connected to a mounting head fixed for rotation to a shaft driven by a small motor. In use, the shaft rotates alternately in a clockwise and in a counter-clockwise sense carrying the mounting head into rotation also, which in turn draws the oscillating wiper arm 9 into rotation and by means of the connecting device 8 moves the wiper blade 2.

The invention is not restricted to the embodiments shown, but also extends to other preferred variants falling within the scope of the appended claims. For example, a skilled person would easily understand that the central longitudinal strip 6 of FIGS. 2 and 3 could well be replaced by two longitudinal strips 6 located in correspondingly shaped grooves 5 in the holding part 3.

1. A windscreen wiper device comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, wherein ends of said longitudinal strip are connected to a respective connecting piece, which windscreen wiper device comprises a connecting device for an oscillating arm, wherein said wiper blade comprises an elongated upper holding part and an elongated lower wiping part of a flexible material, wherein said holding part holds said wiping part, wherein said holding part comprises downwardly extending side arms, seen in cross-section, for pivotally engaging said wiping part from the outside in a lateral region thereof, and wherein additional engaging means are provided for allowing pivotal. engagement between said holding part and said wiping part in an upper region thereof.

2. A windscreen wiper device according to claim 1, wherein said holding part further comprises said additional engaging means downwardly extending for pivotally engaging said wiping part in an upper region thereof.

3. A windscreen wiper device according to claim 1, wherein said wiping part comprises said additional engaging means upwardly extending for pivotally engaging said holding part.

4. A windscreen wiper device according to claim 1, wherein said wiping part comprises a wiping lip, a neck extending from said wiping lip, as well as an enlarged head extending from said neck, and wherein said enlarged head is mounted into a hollow chamber defined by said side arms of said holding part.

5. A windscreen wiper device according to claim 4, wherein said enlarged head has a circular, elliptical, square, rectangular, rhomboid or heart-shaped cross-section.

6. A windscreen wiper device according to claim 4, wherein said additional engaging means engage said enlarged head.

7. A windscreen wiper device according to claim 6, wherein said additional engaging means of said holding part comprise a downwardly extending protrusion engaging said enlarged head in a slit thereof.

8. A windscreen wiper device according to claim 4, wherein said additional engaging means of said wiping part comprise a protrusion extending upwardly from said enlarged head in a slit of said holding part.

9. A windscreen wiper device according to claim 4, wherein said side arms of said holding part comprise inwardly extending end parts, and wherein said neck is located at least partly between said end parts and the enlarged head is located above said end parts.

10. A windscreen wiper device according to claim 4, wherein said hollow chamber includes a lubricant.

11. A windscreen wiper device according to claim 1, wherein said wiping part includes opposing longitudinal grooves on its longitudinal sides, in which grooves spaced-apart longitudinal strips of the carrier element are disposed.

12. A windscreen wiper device according to claim 11, wherein said respective connecting piece interconnects neighbouring ends of said longitudinal strips.

13. A windscreen wiper device according to claim 1, wherein said at least one longitudinal groove is provided in said holding part.

14. A windscreen wiper device according to claim 13, wherein said at least one longitudinal groove has a closed circumference.

15. A windscreen wiper device according to claim 1, wherein said holding part is provided with a spoiler at a side thereof facing away from said wiping part.

16. A windscreen wiper device according to claim 15, wherein said spoiler is in one piece with said holding part.

17. A windscreen wiper device according to claim 15, wherein said spoiler is detachably connected to said holding part.

18. A windscreen wiper device according to claim 1, wherein said holding part and said wiping part extend in longitudinal direction along the entire length of said wiper blade.

19. A windscreen wiper device according to claim 1, wherein said wiping part is at least substantially made of an elastomeric material, such as rubber.

20. A windscreen wiper device according to claim 1, wherein said holding part is at least substantially made of a plastic material.
